(19) United States
(12) Patent Application Publication
(10) Pub. No.: US 2026/0333214 A1
(43) Pub. Date: Oct. 22, 2026

(54) INFORMATION PROCESSING APPARATUS AND AREA SPECIFYING METHOD

(71) Applicant: 1FINITY Inc., Kawasaki-shi (JP)

(72) Inventors: Kazuya FUJITA, Fukuoka (JP); Chikara IMAJO, Fukuoka (JP); Akihiko MAKI, Yokohama (JP); Takuya OMACHI, Fukuoka (JP)

(73) Assignee: 1FINITY Inc., Kawasaki-shi (JP)

(21) Appl. No.: 19/468,751

(22) Filed: Feb. 3, 2026

(30) Foreign Application Priority Data
Feb. 18, 2025 (JP) 2025-024602

(51) Int. Cl. H04W 52/02; H04W 64/00

(52) U.S. Cl. CPC H04W 52/0206; H04W 64/003

(57) ABSTRACT

An information processing apparatus configured to: specify, for each of a plurality of first base station apparatuses arranged in a predetermined area, a first area which is an area in which a communication status with each first base station apparatus satisfies a first condition, based on first information; specify, for each of a plurality of second base station apparatuses arranged in the predetermined area, a second area which is an area in which a communication status with each second base station apparatus satisfies a second condition, based on the first information and second information; specify, for each of the plurality of first base station apparatuses, a third area including the first area corresponding to each first base station apparatus and the second area corresponding to each of the plurality of second base station apparatuses arranged in the first area corresponding to each first base station apparatus.

### CROSS-REFERENCE TO RELATED APPLICATION

This application is based upon and claims the benefit of priority of the prior Japanese Patent Application No. 2025-024602, filed on Feb. 18, 2025, the entire contents of which are incorporated herein by reference.

### FIELD

The present disclosure relates to an information processing apparatus and an area specifying method.

### BACKGROUND

In recent years, in the field of wireless communication systems, for example, a method of suppressing power consumption in each base station apparatus has been studied. Specifically, in the field of wireless communication systems as described above, for example, a method of suppressing power consumption in the entire system by stopping transmission of radio waves from a base station apparatus that can be determined to have a low traffic load (hereinafter, also referred to as a specific base station apparatus) and performing control of reconnecting a terminal apparatus connected to the specific base station apparatus to another base station apparatus (hereinafter, also referred to as transmission suspension control) has been studied (see, for example, JP 2023-066415 A, JP 2023-535841 A, and JP 2024-044125 A).

### SUMMARY

However, for example, in a case where an area (range) to be subjected to the above-described transmission suspension control is set to be wide, in other words, in a case where the number of base station apparatuses to be subjected to the transmission suspension control is increased, the amount of calculation accompanying the execution of the transmission suspension control may become enormous in the wireless communication system. On the other hand, for example, in a case where the area (range) to be subjected to the above-described transmission suspension control is set to be narrow, in other words, in a case where the number of base station apparatuses to be subjected to the transmission suspension control is decreased, it may be difficult for the wireless communication system to accurately specify a base station apparatus (specific base station apparatus) whose radio wave transmission is to be stopped.

Therefore, in the wireless communication system as described above, for example, it is desired to specify an area in which the transmission suspension control can be performed efficiently and accurately.

An information processing apparatus includes: a memory; and a processor coupled to the memory and the processor configured to: specify, for each of a plurality of first base station apparatuses arranged in a predetermined area, a first area which is an area in which a communication status with each first base station apparatus satisfies a first condition, based on first information regarding each of the plurality of first base station apparatuses; specify, for each of a plurality of second base station apparatuses arranged in the predetermined area, a second area which is an area in which a communication status with each second base station apparatus satisfies a second condition, based on the first information regarding each of the plurality of first base station apparatuses and second information regarding each of the plurality of second base station apparatuses; specify, for each of the plurality of first base station apparatuses, a third area including the first area corresponding to each first base station apparatus and the second area corresponding to each of the plurality of second base station apparatuses arranged in the first area corresponding to each first base station apparatus; and output information indicating the third area for each first base station apparatus.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is diagram for describing the configuration of the wireless communication system 10 according to the first embodiment.

FIG. 2 is diagram for describing the configuration of the wireless communication system 10 according to the first embodiment.

FIG. 3 is diagram for describing the configuration of the wireless communication system 10 according to the first embodiment.

FIG. 4 is a diagram for describing functions of the information processing apparatus 4.

FIG. 5 is a flowchart illustrating an outline of the base station control processing according to the first embodiment.

FIG. 6 is flowchart for describing details of the base station control processing according to the first embodiment.

FIG. 7 is flowchart for describing details of the base station control processing according to the first embodiment.

FIG. 8 is flowchart for describing details of the base station control processing according to the first embodiment.

FIG. 9 is flowchart for describing details of the base station control processing according to the first embodiment.

FIG. 10 is diagram for describing details of the base station control processing according to the first embodiment.

FIG. 11 is diagram for describing details of the base station control processing according to the first embodiment.

FIG. 12 is diagram for describing details of the base station control processing according to the first embodiment.

FIG. 13 is diagram for describing details of the base station control processing according to the first embodiment.

FIG. 14 is diagram for describing details of the base station control processing according to the first embodiment.

FIG. 15 is diagram for describing details of the base station control processing according to the first embodiment.

FIG. 16 is diagram for describing details of the base station control processing according to the first embodiment.

FIG. 17 is diagram for describing details of the base station control processing according to the first embodiment.

FIG. 18 is diagram for describing details of the base station control processing according to the first embodiment.

FIG. 19 is diagram for describing details of the base station control processing according to the first embodiment.

FIG. 20 is diagram for describing details of the base station control processing according to the first embodiment.

FIG. 21 is diagram for describing details of the base station control processing according to the first embodiment.

### DESCRIPTION OF EMBODIMENTS

Hereinafter, an embodiment of the present disclosure will be described with reference to the drawings. However, such description is not to be construed in a limiting sense and does not limit the claimed subject matter. In addition, various changes, substitutions, and modifications can be made without departing from the gist and scope of the present disclosure. In addition, different embodiments can be appropriately combined.

### Configuration of Wireless Communication System According to First Embodiment

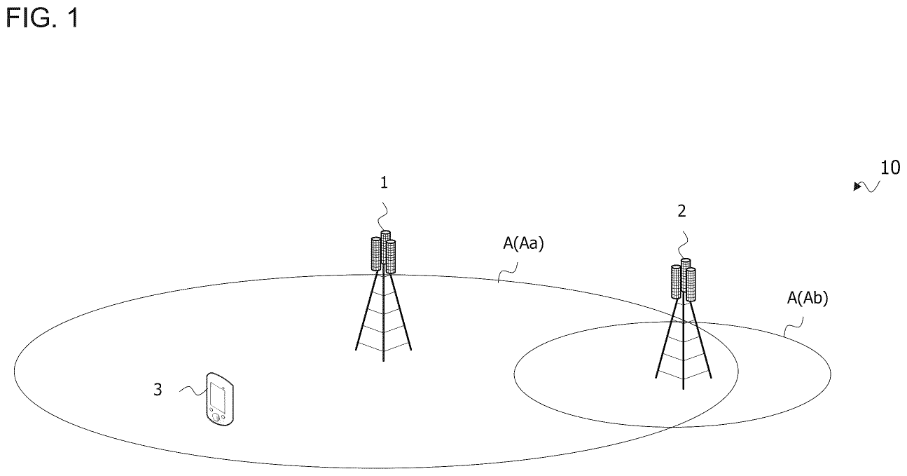

First, a configuration of a wireless communication system 10 according to a first embodiment will be described. FIGS. 1 to 3 are diagrams for describing the configuration of the wireless communication system 10 according to the first embodiment.

For example, the wireless communication system 10 is a wireless communication system compliant with a communication standard of a 5th generation mobile communication system (5G) or a communication standard of a generation after 5G.

Specifically, for example, the wireless communication system 10 includes a base station apparatus 1, a base station apparatus 2, and a terminal apparatus 3 as illustrated in FIG. 1.

The base station apparatus 1 is, for example, a first type of base station apparatus. Then, the base station apparatus 1 forms, for example, a cell A (hereinafter, also referred to as a cell Aa). Specifically, the base station apparatus 1 is, for example, a macro base station (MBS). Hereinafter, a case where the base station apparatus 1 is an MBS will be described.

The base station apparatus 2 is, for example, a base station apparatus arranged in the cell Aa, and is a second type of base station apparatus different from the first type. Then, the base station apparatus 2 forms, for example, another cell A (hereinafter, also referred to as a cell Ab) partially overlapping the cell Aa. Specifically, the base station apparatus 2 is, for example, a small base station (SBS). Hereinafter, a case where the base station apparatus 2 is an SBS will be described.

The terminal apparatus 3 is, for example, a terminal apparatus such as a smartphone carried by an individual or a communication device such as an IoT device installed outdoors. Specifically, for example, in a case where the terminal apparatus 3 is located in the cell Aa, the terminal apparatus 3 performs wireless connection with the base station apparatus 1.

In the example illustrated in FIG. 1, the wireless communication system 10 includes one base station apparatus 1, but the number of base station apparatuses 1 included in the wireless communication system 10 is not limited thereto. Specifically, the wireless communication system 10 may include, for example, a plurality of base station apparatuses 1. Further, in the example illustrated in FIG. 1, the wireless communication system 10 includes one base station apparatus 2, but the number of base station apparatuses 2 included in the wireless communication system 10 is not limited thereto. Specifically, the wireless communication system 10 may include, for example, a plurality of base station apparatuses 2.

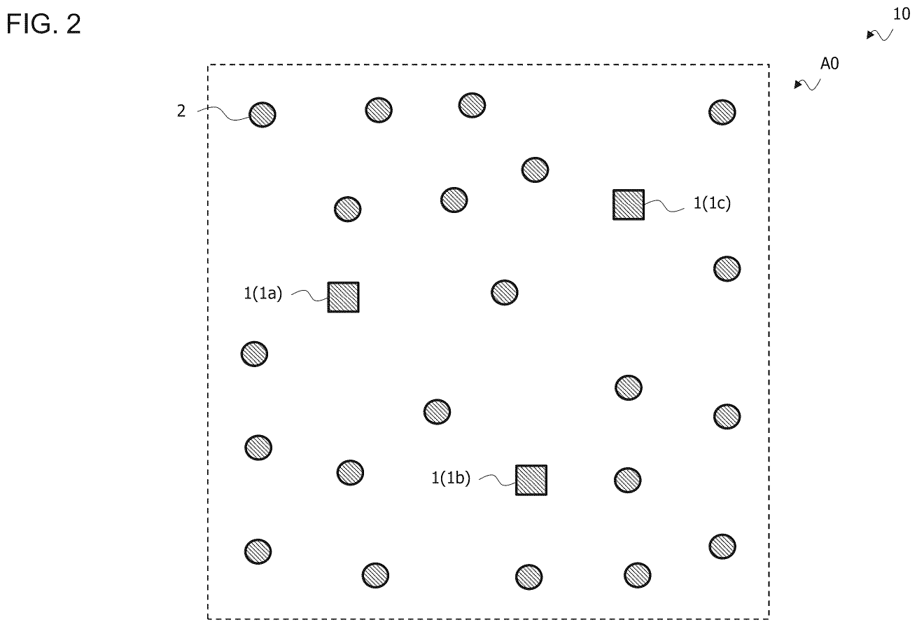

That is, as illustrated in FIG. 2, the wireless communication system 10 may include, for example, a plurality of base station apparatuses 1 (a base station apparatus 1a, a base station apparatus 1b, and a base station apparatus 1c) and a plurality of base station apparatuses 2. In the example illustrated in FIG. 2, an area A0 is, for example, a virtual area indicating arrangement locations of the plurality of base station apparatuses 1 and the plurality of base station apparatuses 2.

Further, in the example illustrated in FIG. 1, the wireless communication system 10 includes one terminal apparatus 3, but the number of terminal apparatuses 3 included in the wireless communication system 10 is not limited thereto. Specifically, the wireless communication system 10 may include, for example, a plurality of terminal apparatuses 3.

Then, in the case of the wireless communication system 10, for example, power consumption of the entire wireless communication system 10 may be suppressed. Specifically, in the case of the wireless communication system 10, for example, power consumption in the wireless communication system 10 may be suppressed by stopping transmission of radio waves from a specific base station apparatus 2 that can be determined to have a low traffic load, and performing transmission suspension control of reconnecting the terminal apparatus 3 connected to the specific base station apparatus 2 to another base station apparatus 2 (a base station apparatus 2 other than the specific base station apparatus 2).

However, for example, in a case where an area (range) to be subjected to the transmission suspension control is set to be wide, in other words, in a case where the number of base station apparatuses 2 to be subjected to the transmission suspension control is increased, an amount of calculation accompanying the execution of the transmission suspension control may become enormous in the wireless communication system 10. On the other hand, for example, in a case where the area (range) to be subjected to the transmission suspension control is set to be narrow, in other words, in a case where the number of base station apparatuses 2 to be subjected to the transmission suspension control is decreased, it may be difficult for the wireless communication system 10 to accurately specify the specific base station apparatus 2.

Therefore, the wireless communication system 10 according to the present embodiment specifies an area (hereinafter, also referred to as a first area) in which a communication status with each base station apparatus 1 satisfies a condition (hereinafter, also referred to as a first condition) for each of the plurality of base station apparatuses 1 based on, for example, information (hereinafter, also referred to as first base station information or first information) regarding each of the plurality of base station apparatuses 1 (hereinafter, also referred to as first base station apparatuses 1) arranged in a predetermined area. The predetermined area is, for example, an area designated in advance by an administrator of the wireless communication system 10 (hereinafter, also simply referred to as the administrator). In addition, the first area is, for example, an area in which a communication status between each base station apparatus 1 and a communication device (for example, the terminal apparatus 3 or a virtual communication device assumed to be arranged in the first area) arranged in the first area satisfies the first condition. In addition, the first area is, for example, an area in which a communication device for which a received intensity of radio waves from each base station apparatus 1 is the highest among received intensities of radio waves from the plurality of base station apparatuses 1 is arranged.

Specifically, in this case, for example, the wireless communication system 10 according to the present embodiment specifies the first area corresponding to each base station apparatus 1 in a case where radio waves are transmitted from each of the plurality of base station apparatuses 1 and radio waves are not transmitted from each of the plurality of base station apparatuses 2 (hereinafter, also referred to as second base station apparatuses 2) arranged in the predetermined area.

Then, the wireless communication system 10 according to the present embodiment specifies an area (hereinafter, also referred to as a second area) in which a communication status with each base station apparatus 2 satisfies a condition (hereinafter, also referred to as a second condition) for each of the plurality of base station apparatuses 2 based on, for example, the first base station information regarding each of the plurality of base station apparatuses 1 and information (hereinafter, also referred to as second base station information or second information) regarding each of the plurality of base station apparatuses 2. The second area is, for example, an area in which a communication status between each base station apparatus 2 and a communication device (for example, the terminal apparatus 3 or a virtual communication device assumed to be arranged in the second area) arranged in the second area satisfies the second condition. In addition, the second area is, for example, an area in which a communication device for which a received intensity of radio waves from each base station apparatus 2 is the highest among received intensities of radio waves from the plurality of base station apparatuses 2 is arranged.

Specifically, in this case, for example, the wireless communication system 10 according to the present embodiment specifies the second area corresponding to each base station apparatus 2 in a case where radio waves are transmitted from each of the plurality of base station apparatuses 1 and the plurality of base station apparatuses 2.

Furthermore, for example, the wireless communication system 10 according to the present embodiment specifies, for each of the plurality of base station apparatuses 1, an area (hereinafter, also referred to as a third area) including the first area corresponding to each base station apparatus 1 and the second area corresponding to each of the plurality of base station apparatuses 2 arranged in the first area corresponding to each base station apparatus 1. Thereafter, the wireless communication system 10 according to the present embodiment outputs, for example, information indicating the third area for each base station apparatus 1.

That is, the wireless communication system 10 according to the present embodiment specifies, for example, the first area in which the terminal apparatus 3 having a high possibility of being connected to each base station apparatus 1 is located for each of the plurality of base station apparatuses 1. In addition, the wireless communication system 10 according to the present embodiment specifies, for example, the second area including an area in which the terminal apparatus 3 having a high possibility of being connected to each base station apparatus 2 arranged in the first area corresponding to each base station apparatus 1 is located and which is not included in the first area corresponding to each base station apparatus 1. Then, the wireless communication system 10 according to the present embodiment specifies, for example, the third area including the specified first area and the specified second area as an area to be subjected to the transmission suspension control (an area of a unit for performing the transmission suspension control).

As a result, the wireless communication system 10 according to the present embodiment can suppress the execution of the transmission suspension control in a form in which traffic with some terminal apparatuses 3 connected to each base station apparatus 1 or each base station apparatus 2 arranged in the first area corresponding to each base station apparatus 1 is not considered even when the area to be subjected to the transmission suspension control is set in a divided manner, for example. Therefore, the wireless communication system 10 according to the present embodiment can suppress the occurrence of a situation in which transmission of radio waves from the base station apparatus 2 that needs to continue the transmission of radio waves is stopped in the transmission suspension control, for example.

Accordingly, the wireless communication system 10 according to the present embodiment can accurately specify the specific base station apparatus 2, for example, even in a case where the area to be subjected to the transmission suspension control is set to be narrow. Therefore, the wireless communication system 10 according to the present embodiment can accurately specify the specific base station apparatus 2 while reducing the amount of calculation accompanying the execution of the transmission suspension control, for example.

### Hardware Configuration of Wireless Communication System

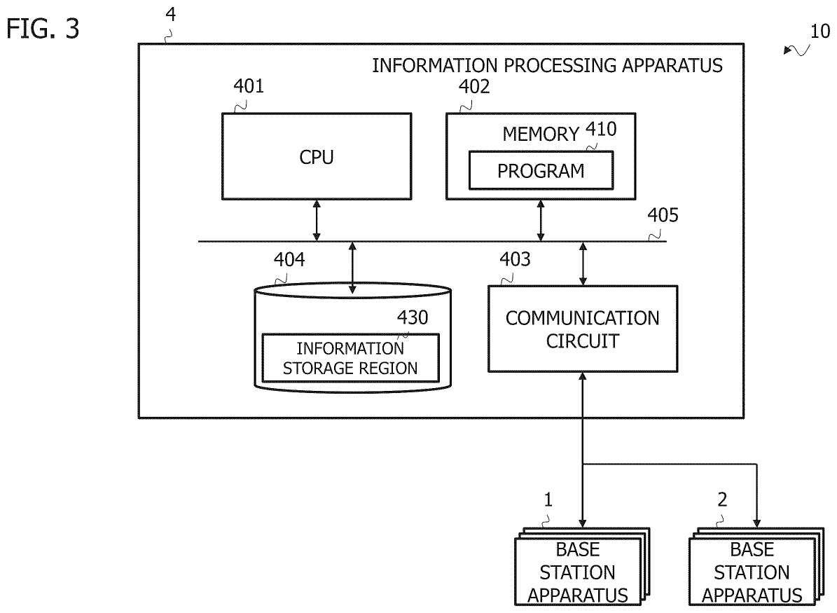

Next, a hardware configuration of the wireless communication system 10 will be described. FIG. 3 is a diagram for describing a hardware configuration of an information processing apparatus 4.

As illustrated in FIG. 3, the wireless communication system 10 further includes, for example, the information processing apparatus 4. As illustrated in FIG. 3, for example, the information processing apparatus 4 includes a central processing unit (CPU) 401 that is a processor, a memory 402, a communication circuit 403, and a storage device 404. The units are connected to one another via a bus 405.

The storage device 404 includes, for example, a program storage region (not illustrated) that stores a program 410 for executing processing (hereinafter, also referred to as base station control processing) for performing the transmission suspension control in each base station apparatus 2. Specifically, the base station control processing includes, for example, processing of specifying one or more third areas from the predetermined area. In addition, the base station control processing includes, for example, processing of performing the transmission suspension control for each of the one or more specified third areas.

In addition, for example, the storage device 404 includes a storage unit 430 (hereinafter, also referred to as an information storage region 430) that stores information to be used when the base station control processing is performed. For example, the storage device 404 may be a hard disk drive (HDD) or a solid state drive (SSD).

As illustrated in FIG. 3, for example, the CPU 401 executes the program 410 loaded from the storage device 404 into the memory 402 to execute the base station control processing.

The communication circuit 403 performs, for example, wired connection or wireless connection with the base station apparatus 1 or the base station apparatus 2.

### Function of Information Processing Apparatus 4

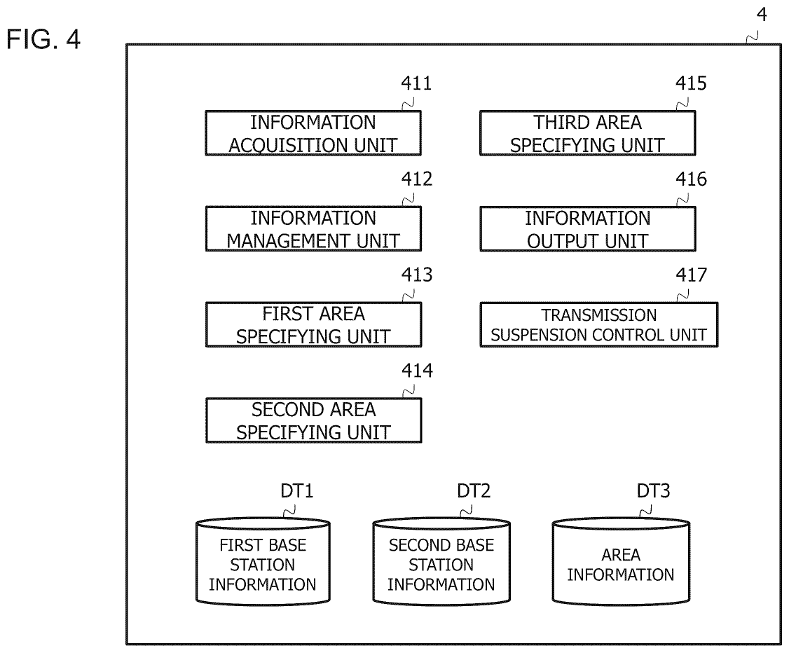

Next, functions of the wireless communication system 10 will be described. FIG. 4 is a diagram for describing functions of the information processing apparatus 4.

As illustrated in FIG. 4, for example, hardware such as the CPU 401 and the memory 402 and the program 410 cooperate organically, whereby the information processing device 4 implements various functions including an information acquisition unit 411, an information management unit 412, a first area specifying unit 413, a second area specifying unit 414, a third area specifying unit 415, an information output unit 416, and a transmission suspension control unit 417.

In addition, as illustrated in FIG. 4, the base station apparatus 1 stores, for example, first base station information DT1, second base station information DT2, and area information DT3 in the information storage region 430.

The information acquisition unit 411 receives, for example, the first base station information DT1 transmitted from each base station apparatus 1. The first base station information DT1 includes, for example, location information (for example, longitude and latitude at a location where each base station apparatus 1 is arranged) of each base station apparatus 1. In addition, the first base station information DT1 includes, for example, a height of an antenna (not illustrated) of each base station apparatus 1. In addition, the first base station information DT1 includes, for example, transmission power and a frequency of radio waves transmitted from each base station apparatus 1. Then, the information management unit 412 stores, for example, the first base station information DT1 received by the information acquisition unit 411 in the information storage region 430.

For example, the information acquisition unit 411 may access each base station apparatus 1 to acquire the first base station information DT1. Then, for example, the information management unit 412 may store the first base station information DT1 acquired by the information acquisition unit 411 in the information storage region 430.

In addition, the information acquisition unit 411 receives, for example, the second base station information DT2 transmitted from each base station apparatus 2. The second base station information DT2 includes, for example, location information (for example, longitude and latitude at a location where each base station apparatus 2 is arranged) of each base station apparatus 2. In addition, the second base station information DT2 includes, for example, a height of an antenna (not illustrated) of each base station apparatus 2. In addition, the second base station information DT2 includes, for example, transmission power and a frequency of radio waves transmitted from each base station apparatus 2.

For example, the information acquisition unit 411 may access each base station apparatus 2 to acquire the second base station information DT2. Then, for example, the information management unit 412 may store the second base station information DT2 acquired by the information acquisition unit 411 in the information storage region 430.

For example, the first area specifying unit 413 specifies the first area in which the communication status with each base station apparatus 1 satisfies the first condition for each of the plurality of base station apparatuses 1 based on the first base station information DT1 (the first base station information DT1 stored in the information storage region 430) regarding each of the plurality of base station apparatuses 1 arranged in the predetermined area (hereinafter, also simply referred to as the plurality of base station apparatuses 1).

That is, in this case, for example, the first area specifying unit 413 specifies the first area corresponding to each base station apparatus 1 in a case where it is assumed that radio waves are transmitted from each of the plurality of base station apparatuses 1 and radio waves are not transmitted from each of the plurality of base station apparatuses 2.

Specifically, for example, the first area specifying unit 413 specifies, as the first area, an area in which the communication device (for example, the terminal apparatus 3 or the virtual communication device assumed to be arranged in the first area) whose communication status with each base station apparatus 1 satisfies the first condition is arranged, for each of the plurality of base station apparatuses 1 based on the first base station information DT1 regarding each of the plurality of base station apparatuses 1.

More specifically, for example, the first area specifying unit 413 specifies, as the first area, an area in which the communication device for which the received intensity of radio waves from each base station apparatus 1 is the highest is arranged, in the predetermined area for each of the plurality of base station apparatuses 1 by using the location information, the height of the antenna, the transmission power of radio waves, and the frequency of radio waves, which are included in the first base station information DT1 corresponding to the plurality of base station apparatuses 1.

For example, the second area specifying unit 414 specifies the second area in which the communication status with each base station apparatus 2 satisfies the second condition for each of the plurality of base station apparatuses 2 based on the first base station information DT1 (the first base station information DT1 stored in the information storage region 430) regarding each of the plurality of base station apparatuses 1 arranged in the predetermined area and the second base station information DT2 (the second base station information DT2 stored in the information storage region 430) regarding each of the plurality of base station apparatuses 2 arranged in the predetermined area (hereinafter, also simply referred to as the plurality of base station apparatuses 2).

That is, in this case, for example, the second area specifying unit 414 specifies the second area corresponding to each base station apparatus 2 in a case where it is assumed that radio waves are transmitted from each of the plurality of base station apparatuses 1 and radio waves are transmitted from each of the plurality of base station apparatuses 2.

Specifically, for example, the second area specifying unit 414 specifies, as the second area, an area in which the communication device (for example, the terminal apparatus 3 or the virtual communication device assumed to be arranged in the second area) whose communication status with each base station apparatus 2 satisfies the second condition is arranged, for each of the plurality of base station apparatuses 2 based on the first base station information DT1 regarding each of the plurality of base station apparatuses 1 and the second base station information DT2 regarding each of the plurality of base station apparatuses 2.

More specifically, for example, the second area specifying unit 414 specifies, as the second area, an area in which the communication device for which the received intensity of radio waves from each base station apparatus 2 is the highest is arranged, in the predetermined area for each of the plurality of base station apparatuses 2 by using the location information, the height of the antenna, the transmission power of radio waves, and the frequency of radio waves, which are included in the first base station information DT1 corresponding to the plurality of base station apparatuses 1 and the second base station information DT2 corresponding to the plurality of base station apparatuses 2.

For example, the third area specifying unit 415 specifies, as the third area corresponding to each base station apparatus 1, an area including the first area corresponding to each base station apparatus 1 and the second area corresponding to each of the plurality of base station apparatuses 2 arranged in the first area corresponding to each base station apparatus 1, for each of the plurality of base station apparatuses 1. Then, the information management unit 112 stores, for example, the area information DT3 indicating the third area (the third area corresponding to each of the plurality of base station apparatuses 1) specified by the third area specifying unit 415 in the information storage region 430.

That is, for example, the third area specifying unit 415 specifies, as the third area corresponding to each base station apparatus 1, the first area corresponding to each base station apparatus 1 and an area that is not included in the first area corresponding to each base station apparatus 1 in the second area corresponding to each base station apparatus 2, for each of the plurality of base station apparatuses 1.

For example, the information output unit 416 generates the area information DT3 (the area information DT3 stored in the information storage region 430) indicating the third area corresponding to each of the plurality of base station apparatuses 1. Then, the information output unit 416 stores, for example, the generated area information DT3 in the information storage region 430. The information output unit 416 may output the area information DT3 in, for example, an operation terminal (not illustrated) that the administrator can access.

For example, for each of the plurality of base station apparatuses 1, the transmission suspension control unit 417 performs the transmission suspension control for each of the plurality of base station apparatuses 2 arranged in the third area corresponding to each base station apparatus 1.

Specifically, for example, for each of the plurality of base station apparatuses 1, the transmission suspension control unit 417 performs the transmission suspension control for each of the plurality of base station apparatuses 2 arranged in the third area corresponding to each base station apparatus 1 by referring to the area information DT3 stored in the information storage region 430.

### Outline of Base Station Control Processing According to First Embodiment

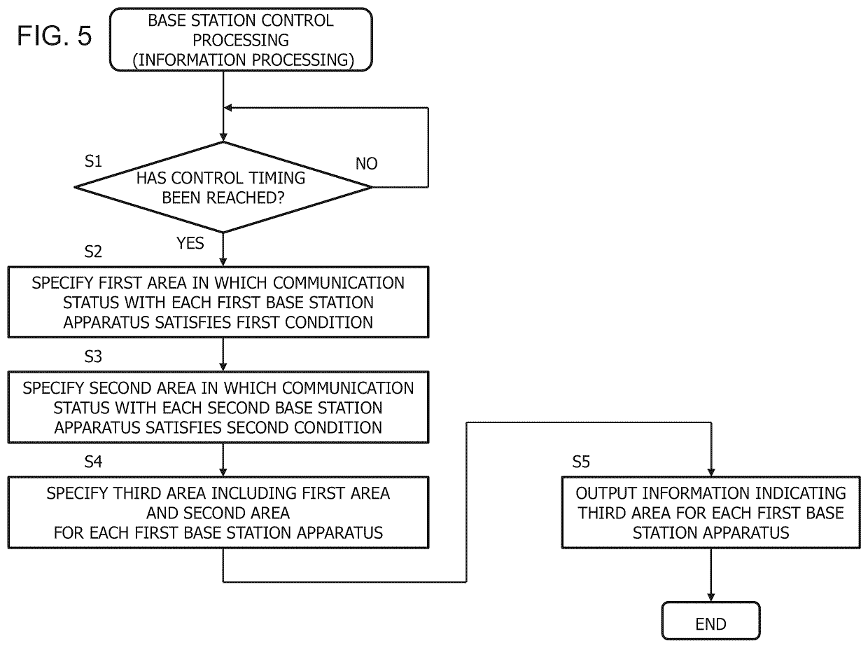

Next, an outline of the base station control processing according to the first embodiment will be described. FIG. 5 is a flowchart illustrating an outline of the base station control processing according to the first embodiment.

As illustrated in FIG. 5, for example, the information processing apparatus 4 waits until a control timing is reached (NO in S1). For example, the control timing may be designated by the administrator.

Then, when the control timing has been reached, the information processing apparatus 4 specifies the first area in which the communication status with each base station apparatus 1 satisfies the first condition for each of the plurality of base station apparatuses 1 based on, for example, the first base station information DT1 regarding each of the plurality of base station apparatuses 1 arranged in the predetermined area (S2).

Subsequently, the information processing apparatus 4 specifies the second area in which the communication status with each base station apparatus 2 satisfies the second condition for each of the plurality of base station apparatuses 2 based on, for example, the first base station information DT1 regarding each of the plurality of base station apparatuses 1 arranged in the predetermined area and the second base station information DT2 regarding each of the plurality of base station apparatuses 2 arranged in the predetermined area (S3).

Furthermore, for example, the information processing apparatus 4 specifies, as the third area corresponding to each base station apparatus 1, the area including the first area corresponding to each base station apparatus 1 and the second area corresponding to each of the plurality of base station apparatuses 2 arranged in the first area corresponding to each base station apparatus 1, for each of the plurality of base station apparatuses 1 (S4).

Thereafter, the information processing apparatus 4 outputs, for example, the area information DT3 indicating the third area corresponding to each of the plurality of base station apparatuses 1 (S5).

As a result, the information processing apparatus 4 according to the present embodiment can accurately specify the specific base station apparatus 2 while reducing the amount of calculation accompanying the execution of the transmission suspension control, for example.

### Details of Base Station Control Processing According to First Embodiment

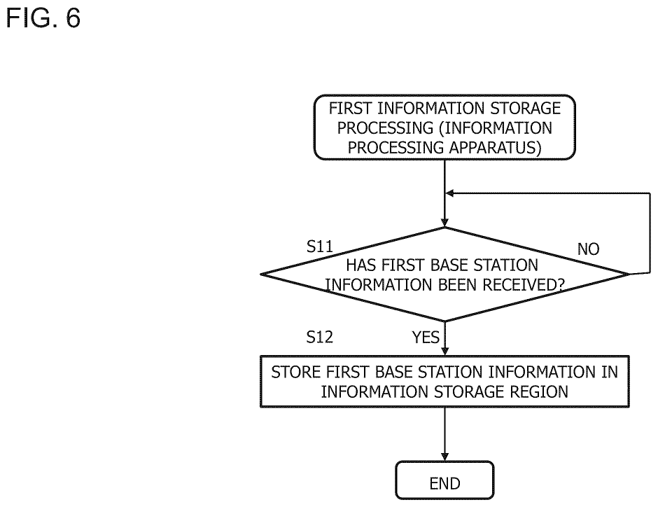

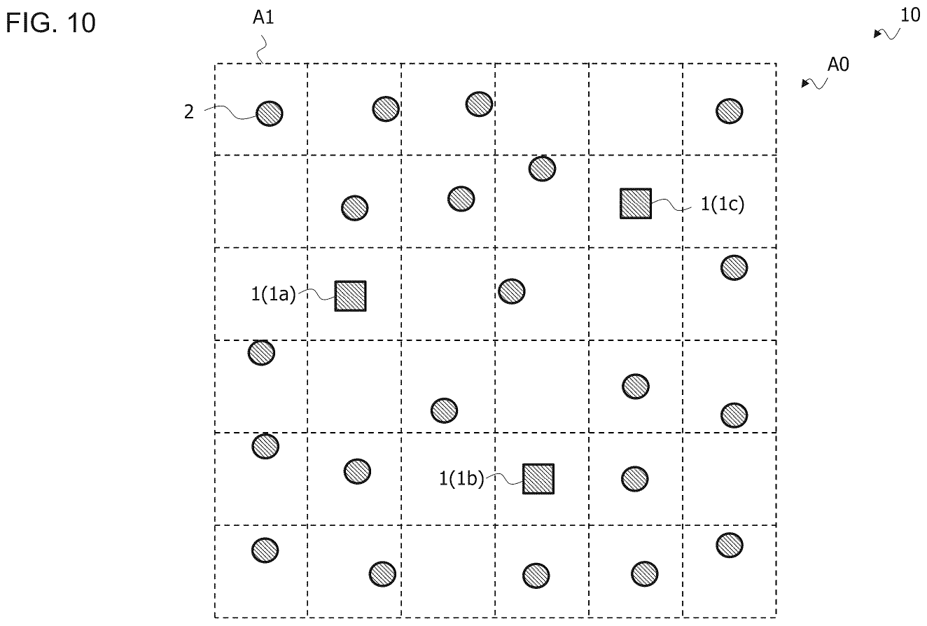

Next, details of the base station control processing according to the first embodiment will be described. FIGS. 6 to 9 are flowcharts for describing details of the base station control processing according to the first embodiment. FIGS. 10 to 21 are diagrams for describing details of the base station control processing according to the first embodiment.

### First Information Storage Processing

First, processing of storing the first base station information DT1 in the information storage region 430 (hereinafter, also referred to as first information storage processing) in the base station control processing according to the first embodiment will be described. FIG. 6 is a flowchart for describing the first information storage processing.

As illustrated in FIG. 6, for example, the information acquisition unit 411 waits until receiving the first base station information DT1 transmitted from any one of the plurality of base station apparatuses 1 arranged in the predetermined area (NO in S11).

Specifically, for example, the information acquisition unit 411 waits until receiving the first base station information DT1 including the location information (for example, longitude and latitude at a location where each base station apparatus 1 is arranged) of each base station apparatus 1, the height of the antenna (not illustrated) of each base station apparatus 1, the transmission power of radio waves transmitted from each base station apparatus 1, and the frequency of radio waves transmitted from each base station apparatus 1.

Then, in a case where the first base station information DT1 transmitted from any one of the plurality of base station apparatuses 1 has been received (YES in S11), the information management unit 412 stores, for example, the received first base station information DT1 in the information storage region 430 (S12).

That is, for example, the information management unit 412 accumulates, in the information storage region 430, the first base station information DT1 of each of the plurality of base station apparatuses 1 arranged in the predetermined area.

### Second Information Storage Processing

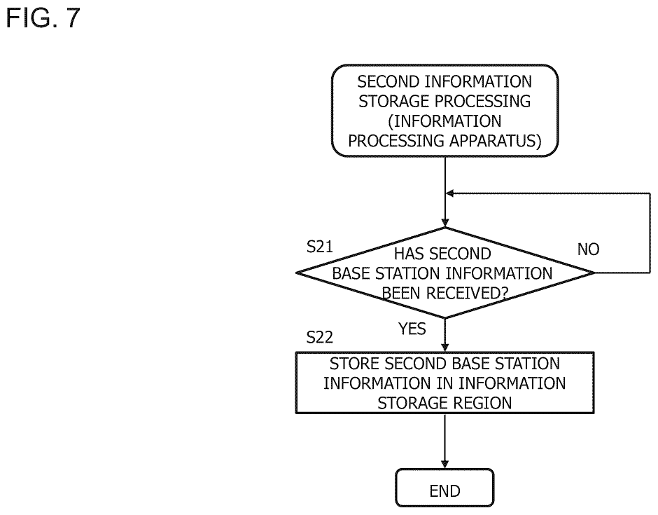

Next, processing of storing the second base station information DT2 in the information storage region 430 (hereinafter, also referred to as second information storage processing) in the base station control processing according to the first embodiment will be described. FIG. 7 is a flowchart for describing the second information storage processing.

As illustrated in FIG. 7, for example, the information acquisition unit 411 waits until receiving the second base station information DT2 transmitted from any one of the plurality of base station apparatuses 2 arranged in the predetermined area (NO in S21).

Specifically, for example, the information acquisition unit 411 waits until receiving the second base station information DT2 including the location information (for example, longitude and latitude at a location where each base station apparatus 2 is arranged) of each base station apparatus 2, the height of the antenna (not illustrated) of each base station apparatus 2, the transmission power of radio waves transmitted from each base station apparatus 2, and the frequency of radio waves transmitted from each base station apparatus 2.

Then, in a case where the second base station information DT2 transmitted from any one of the plurality of base station apparatuses 1 has been received (YES in S21), the information management unit 412 stores, for example, the received second base station information DT2 in the information storage region 430 (S22).

That is, for example, the information management unit 412 accumulates, in the information storage region 430, the second base station information DT2 of each of the plurality of base station apparatuses 2 arranged in the predetermined area.

### Area Specifying Processing

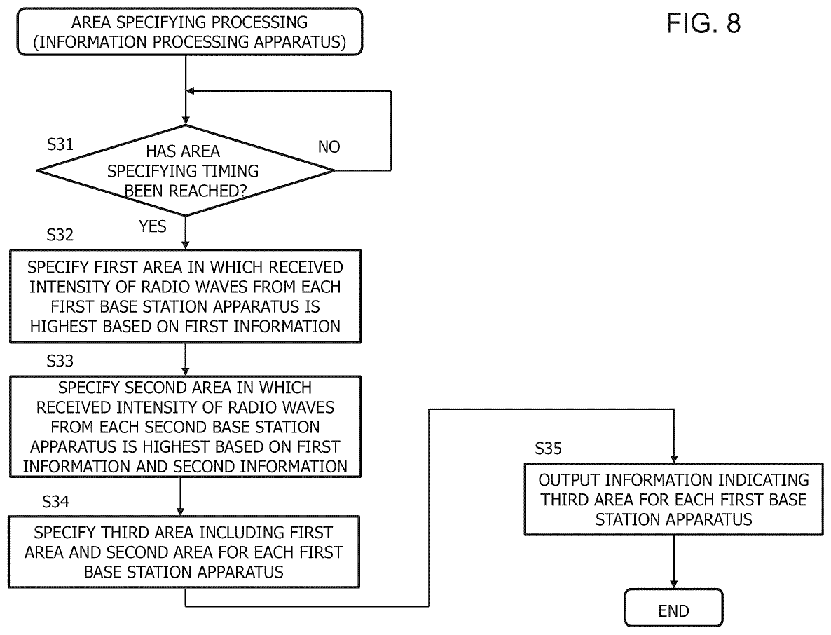

Next, the processing of specifying the third area corresponding to each of the plurality of base station apparatuses 1 (hereinafter, also referred to as area specifying processing) in the base station control processing according to the first embodiment will be described. FIG. 8 is a flowchart for describing the area specifying processing.

As illustrated in FIG. 8, for example, the first area specifying unit 413 waits until an area specifying timing is reached (NO in S31). The area specifying timing is, for example, a timing after the first information storage processing and the second information storage processing are executed, and may be designated by the administrator.

Then, when the area specifying timing has been reached (YES in S31), the first area specifying unit 413 specifies the first area in which the communication status with each base station apparatus 1 satisfies the first condition for each of the plurality of base station apparatuses 1 based on, for example, the first base station information DT1 regarding each of the plurality of base station apparatuses 1 arranged in the predetermined area (S32).

Specifically, for example, the first area specifying unit 413 specifies, as the first area, an area in which the received intensity of radio waves from each base station apparatus 1 is the highest in the predetermined area by using the location information, the height of the antenna, the transmission power of radio waves, and the frequency of radio waves, which are included in the first base station information DT1 corresponding to the plurality of base station apparatuses 1, for each of the plurality of base station apparatuses 1. A specific example of S32 is described below.

### Specific Example of S32

FIGS. 10 to 14 are diagrams for describing the specific example of S32.

As illustrated in FIG. 2, for example, the first area specifying unit 413 virtually arranges each base station apparatus 1 according to the location information included in the first base station information DT1 corresponding to each of the base station apparatuses 1 (the base station apparatus 1a, the base station apparatus 1b, and the base station apparatus 1c), and virtually arranges each base station apparatus 2 according to the location information included in the second base station information DT2 corresponding to the plurality of base station apparatuses 2, in the area A0.

Then, as illustrated in FIG. 10, the first area specifying unit 413 divides the area A0 into a plurality of mesh cells A1. Specifically, as illustrated in FIG. 10, for example, the first area specifying unit 413 divides the area A0 such that sizes of the mesh cells A1 are the same as each other. The respective mesh cells A1 may have different sizes, for example.

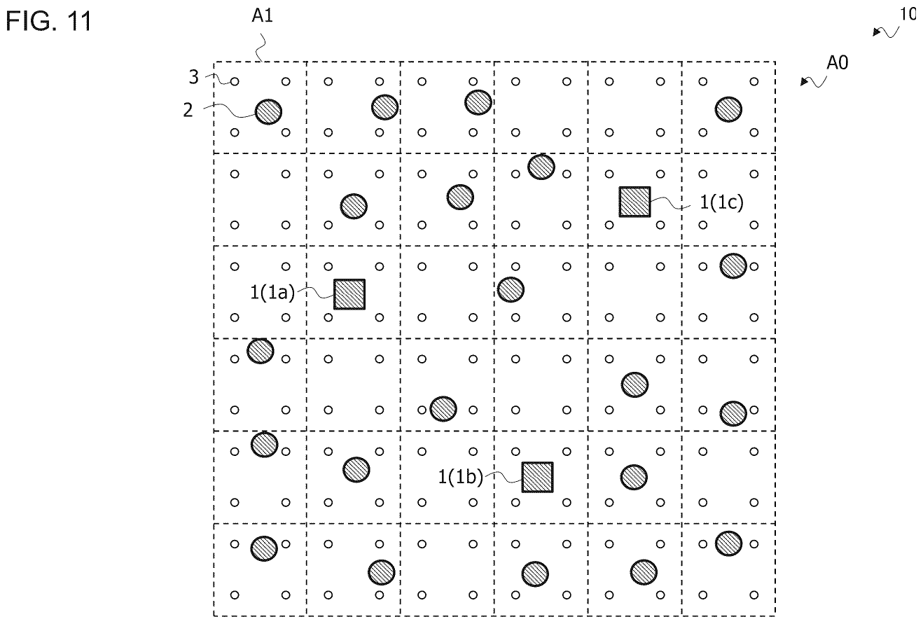

Subsequently, as illustrated in FIG. 11, for example, the first area specifying unit 413 arranges a virtual communication device at a predetermined location in each mesh cell A1. Hereinafter, a case where the virtual communication device is the virtual terminal apparatus 3 (hereinafter, also simply referred to as the terminal apparatus 3) will be described. Specifically, as illustrated in FIG. 11, for example, the first area specifying unit 413 virtually arranges four terminal apparatuses 3 at four locations in each mesh cell A1. The number of terminal apparatuses 3 virtually arranged in each mesh cell A1 may be, for example, a number other than four.

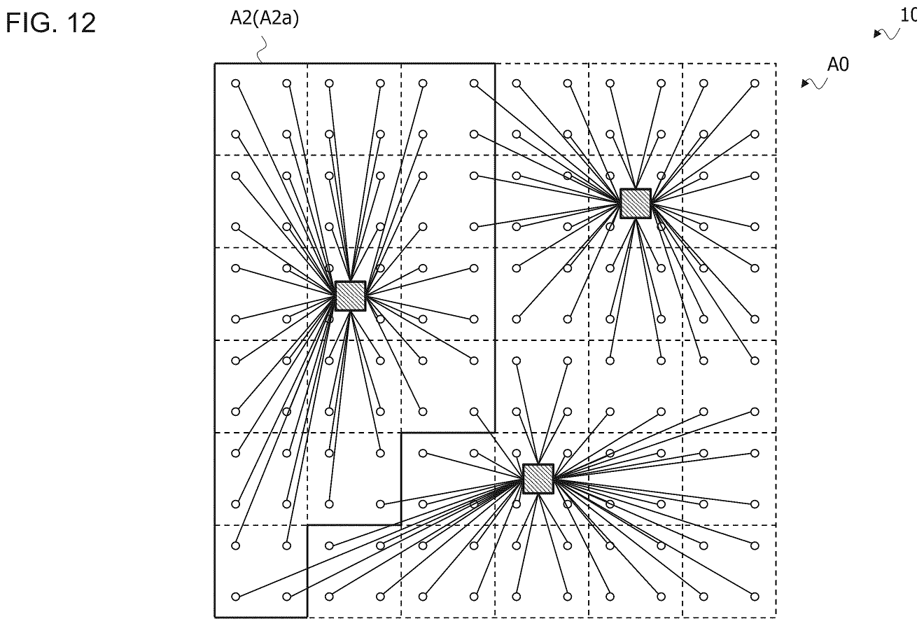

Thereafter, for example, as illustrated in FIG. 12, in a case where it is assumed that each of the base station apparatuses 1 (the base station apparatus 1a, the base station apparatus 1b, and the base station apparatus 1c) is arranged in the area A0, the first area specifying unit 413 specifies, as the first area corresponding to the base station apparatus 1a, an area in which at least one terminal apparatus 3 for which a received intensity of radio waves from the base station apparatus 1a is the highest is arranged, by using the height of the antenna, the transmission power of radio waves, and the frequency of radio waves, which are included in the first base station information DT1 corresponding to the plurality of base station apparatuses 1. In the example illustrated in FIG. 12 and the like, a straight line connecting each base station apparatus 1 and each terminal apparatus 3 is a straight line indicating that the received intensity of radio waves from the base station apparatus 1 is the highest for the terminal apparatus 3.

Specifically, as illustrated in FIG. 12, for example, the first area specifying unit 413 specifies, as the first area corresponding to the base station apparatus 1a, an area A2 (hereinafter, also referred to as an area A2a) including a mesh cell A1 in the first row and the first column, a mesh cell A1 in the first row and the second column, a mesh cell A1 in the first row and the third column, a mesh cell A1 in the second row and the first column, a mesh cell A1 in the second row and the second column, a mesh cell A1 in the second row and the third column, a mesh cell A1 in the third row and the first column, a mesh cell A1 in the third row and the second column, a mesh cell A1 in the third row and the third column, a mesh cell A1 in the fourth row and the first column, a mesh cell A1 in the fourth row and the second column, a mesh cell A1 in the fourth row and the third column, a mesh cell A1 in the fifth row and the first column, a mesh cell A1 in the fifth row and the second column, and a mesh cell A1 in the sixth row and the first column.

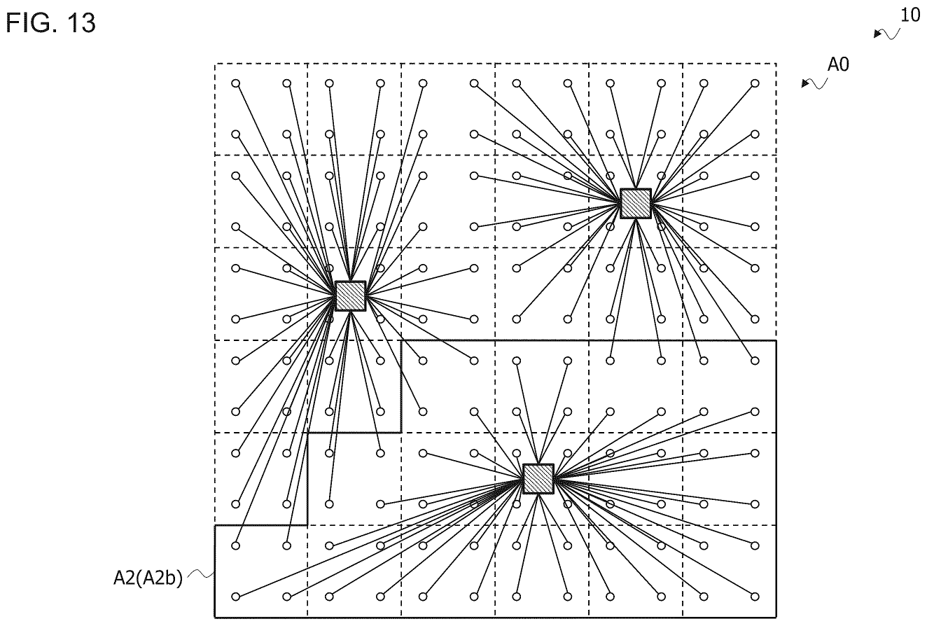

In addition, as illustrated in FIG. 13, for example, in a case where it is assumed that each of the base station apparatuses 1 (the base station apparatus 1a, the base station apparatus 1b, and the base station apparatus 1c) is arranged in the area A0, the first area specifying unit 413 specifies, as the first area corresponding to the base station apparatus 1b, an area in which at least one terminal apparatus 3 for which a received intensity of radio waves from the base station apparatus 1b is the highest is arranged, by using the height of the antenna, the transmission power of radio waves, and the frequency of radio waves, which are included in the first base station information DT1 corresponding to the plurality of base station apparatuses 1.

Specifically, as illustrated in FIG. 13, for example, the first area specifying unit 413 specifies, as the first area corresponding to the base station apparatus 1b, an area A2 (hereinafter, also referred to as an area A2b) including a mesh cell A1 in the fourth row and the third column, a mesh cell A1 in the fourth row and the fourth column, a mesh cell A1 in the fourth row and the fifth column, a mesh cell A1 in the fourth row and the sixth column, a mesh cell A1 in the fifth row and the second column, a mesh cell A1 in the fifth row and the third column, a mesh cell A1 in the fifth row and the fourth column, a mesh cell A1 in the fifth row and the fifth column, a mesh cell A1 in the fifth row and the sixth column, a mesh cell A1 in the sixth row and the first column, a mesh cell A1 in the sixth row and the second column, a mesh cell A1 in the sixth row and the third column, a mesh cell A1 in the sixth row and the fourth column, a mesh cell A1 in the sixth row and the fifth column, and a mesh cell A1 in the sixth row and the sixth column.

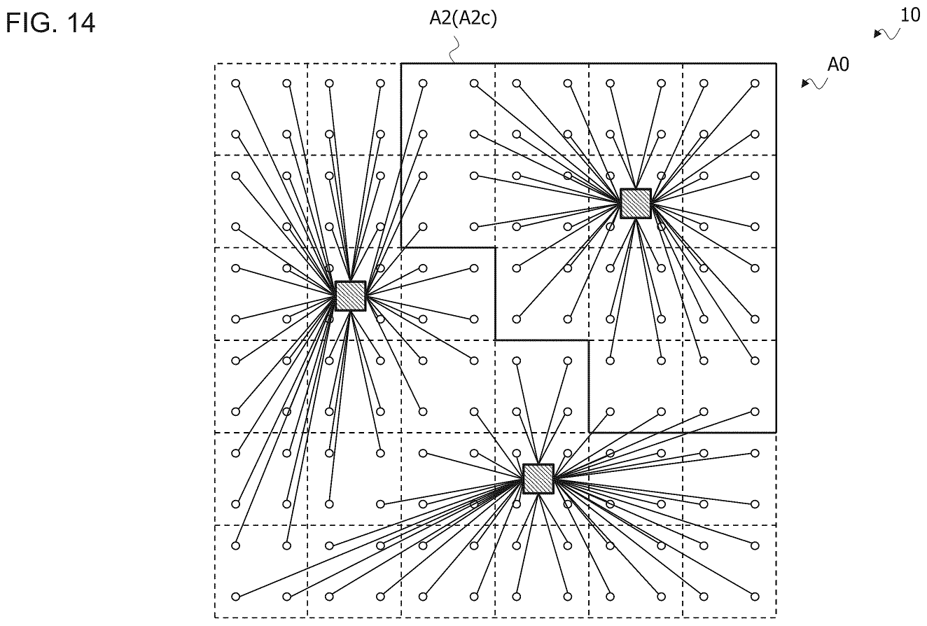

In addition, as illustrated in FIG. 14, for example, in a case where it is assumed that each of the base station apparatuses 1 (the base station apparatus 1a, the base station apparatus 1b, and the base station apparatus 1c) is arranged in the area A0, the first area specifying unit 413 specifies, as the first area corresponding to the base station apparatus 1c, an area in which at least one terminal apparatus 3 for which a received intensity of radio waves from the base station apparatus 1c is the highest is arranged, by using the height of the antenna, the transmission power of radio waves, and the frequency of radio waves, which are included in the first base station information DT1 corresponding to the plurality of base station apparatuses 1.

Specifically, as illustrated in FIG. 14, for example, the first area specifying unit 413 specifies, as the first area corresponding to the base station apparatus 1c, an area A2 (hereinafter, also referred to as an area A2c) including a mesh cell A1 in the first row and the third column, a mesh cell A1 in the first row and the fourth column, a mesh cell A1 in the first row and the fifth column, a mesh cell A1 in the first row and the sixth column, a mesh cell A1 in the second row and the third column, a mesh cell A1 in the second row and the fourth column, a mesh cell A1 in the second row and the fifth column, a mesh cell A1 in the second row and the sixth column, a mesh cell A1 in the third row and the fourth column, a mesh cell A1 in the third row and the fifth column, a mesh cell A1 in the third row and the sixth column, a mesh cell A1 in the fourth row and the fifth column, and a mesh cell A1 in the fourth row and the sixth column.

Returning to FIG. 8, the second area specifying unit 414 specifies the second area in which the communication status with each base station apparatus 1 or each base station apparatus 2 satisfies the second condition for each of the plurality of base station apparatuses 1 and the plurality of base station apparatuses 2 based on, for example, the first base station information DT1 regarding each of the plurality of base station apparatuses 1 arranged in the predetermined area and the second base station information DT2 regarding each of the plurality of base station apparatuses 2 arranged in the predetermined area (S33).

Specifically, for example, the second area specifying unit 414 specifies, as the second area, an area in which the received intensity of radio waves from each base station apparatus 1 or each base station apparatus 2 is the highest, in the predetermined area for each of the plurality of base station apparatuses 1 and the plurality of base station apparatuses 2 by using the location information, the height of the antenna, the transmission power of radio waves, and the frequency of radio waves, which are included in the first base station information DT1 corresponding to the plurality of base station apparatuses 1, and the second base station information DT2 corresponding to the plurality of base station apparatuses 2. A specific example of S33 is described below.

### Specific Example of S33

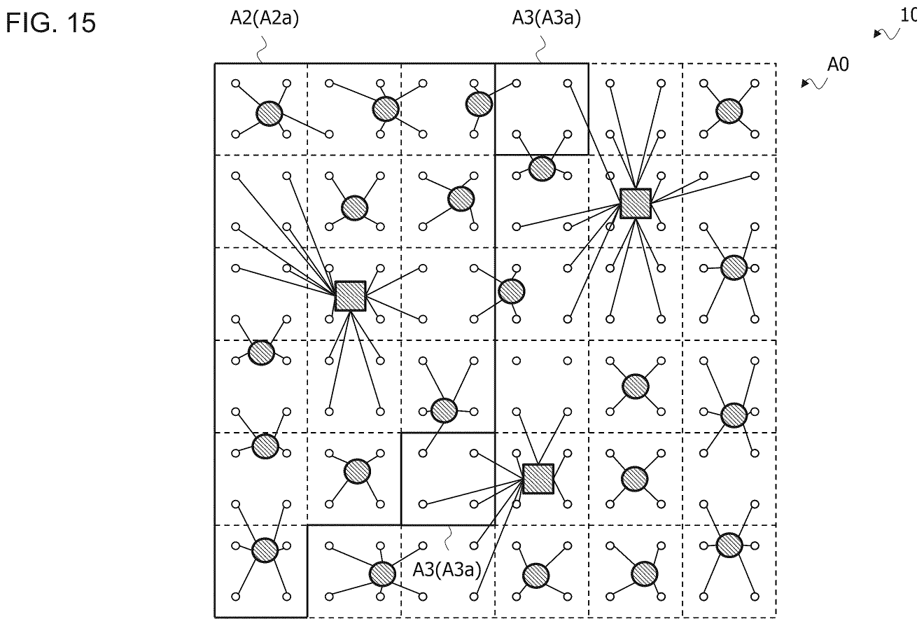

FIGS. 15 to 20 are diagrams for describing the specific example of S33.

As illustrated in FIG. 15, for example, in a case where it is assumed that each of the base station apparatuses 1 (the base station apparatus 1a, the base station apparatus 1b, and the base station apparatus 1c) and each base station apparatus 2 are arranged in the area A0, the second area specifying unit 414 specifies, as the second area corresponding to the base station apparatus 1a, an area in which at least one terminal apparatus 3 for which the received intensity of radio waves from the base station apparatus 1a is the highest is arranged, by using the height of the antenna, the transmission power of radio waves, and the frequency of radio waves, which are included in the first base station information DT1 corresponding to the plurality of base station apparatuses 1, and the second base station information DT2 corresponding to the plurality of base station apparatuses 2.

Specifically, the second area specifying unit 414 specifies, as the second area corresponding to the base station apparatus 1a, for example, an area including the mesh cell A1 in the second row and the first column, the mesh cell A1 in the third row and the first column, the mesh cell A1 in the third row and the second column, the mesh cell A1 in the third row and the third column, and the mesh cell A1 in the fourth row and the second column as indicated by arrangement locations of the terminal apparatus 3 connected to the base station apparatus 1a by straight lines in FIG. 15.

In addition, as illustrated in FIG. 15, for example, in a case where it is assumed that each of the base station apparatuses 1 (the base station apparatus 1a, the base station apparatus 1b, and the base station apparatus 1c) and each base station apparatus 2 are arranged in the area A0, the second area specifying unit 414 specifies, as the second area corresponding to each base station apparatus 2, an area in which at least one terminal apparatus 3 for which the reception intensity of radio waves from each base station apparatus 2 is the highest is arranged for each base station apparatus 2 arranged in the area A2a (the area A2a corresponding to the base station apparatus 1a) specified in S32, by using the height of the antenna, the transmission power of radio waves, and the frequency of radio waves, which are included in the first base station information DT1 corresponding to the plurality of base station apparatuses 1, and the second base station information DT2 corresponding to the plurality of base station apparatuses 2.

Specifically, the second area specifying unit 414 specifies, as the second area corresponding to the base station apparatus 2 arranged in the mesh cell A1 in the first row and the first column, for example, an area including the mesh cell A1 in the first row and the first column and the mesh cell A1 in the first row and the second column as indicated by the arrangement locations of the terminal apparatus 3 connected to each base station apparatus 2 by straight lines in FIG. 15. For example, the second area specifying unit 414 specifies, as the second area corresponding to the base station apparatus 2 arranged in the mesh cell A1 in the first row and the second column, an area including the mesh cell A1 in the first row and the second column and the mesh cell A1 in the first row and the third column. For example, the second area specifying unit 414 specifies, as the second area corresponding to the base station apparatus 2 arranged in the mesh cell A1 in the first row and the third column, an area including the mesh cell A1 in the first row and the third column and the mesh cell A1 in the first row and the fourth column. For example, the second area specifying unit 414 specifies, as the second area corresponding to the base station apparatus 2 arranged in the mesh cell A1 in the second row and the second column, an area including the mesh cell A1 in the second row and the second column. For example, the second area specifying unit 414 specifies, as the second area corresponding to the base station apparatus 2 arranged in the mesh cell A1 in the second row and the third column, an area including the mesh cell A1 in the second row and the third column. For example, the second area specifying unit 414 specifies, as the second area corresponding to the base station apparatus 2 arranged in the mesh cell A1 in the fourth row and the first column, an area including the mesh cell A1 in the third row and the first column and the mesh cell A1 in the fourth row and the first column. For example, the second area specifying unit 414 specifies, as the second area corresponding to the base station apparatus 2 arranged in the mesh cell A1 in the fourth row and the third column, an area including the mesh cell A1 in the fourth row and the third column and the mesh cell A1 in the fifth row and the third column. For example, the second area specifying unit 414 specifies, as the second area corresponding to the base station apparatus 2 arranged in the mesh cell A1 in the fifth row and the first column, an area including the mesh cell A1 in the fourth row and the first column and the mesh cell A1 in the fifth row and the first column. For example, the second area specifying unit 414 specifies, as the second area corresponding to the base station apparatus 2 arranged in the mesh cell A1 in the fifth row and the second column, an area including the mesh cell A1 in the fifth row and the second column. For example, the second area specifying unit 414 specifies, as the second area corresponding to the base station apparatus 2 arranged in the mesh cell A1 in the sixth row and the first column, an area including the mesh cell A1 in the fifth row and the first column and the mesh cell A1 in the sixth row and the first column.

Furthermore, in this case, as illustrated in FIG. 15, for example, the second area specifying unit 414 specifies the mesh cell A1 in the first row and the fourth column and the mesh cell A1 in the fifth row and the third column as the mesh cells A1 that are not included in the area A2a specified in S32 among the mesh cells A1 included in the second area corresponding to each base station apparatus 2 arranged in the area A2a specified in S32 (the area A2a corresponding to the base station apparatus 1a). Then, for example, the second area specifying unit 414 specifies, as an area A3 (hereinafter, also referred to as an area A3a), an area including the specified mesh cell A1 in the first row and the fourth column and the specified mesh cell A1 in the fifth row and the third column.

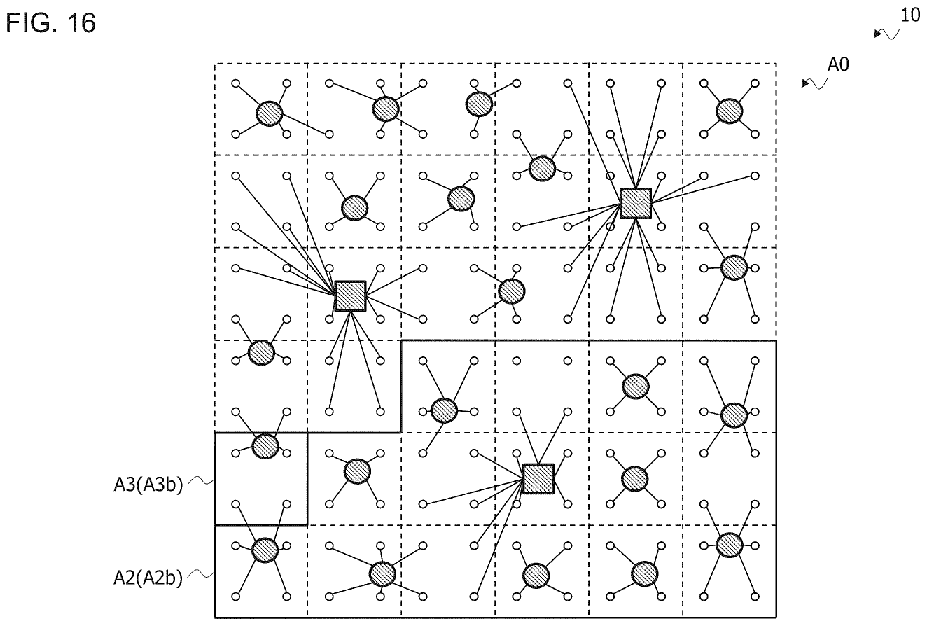

Similarly, in this case, as illustrated in FIG. 16, for example, the second area specifying unit 414 specifies the mesh cell A1 in the fifth row and the first column as the mesh cell A1 that is not included in the area A2b specified in S32 among the mesh cells A1 included in the second area corresponding to each base station apparatus 2 arranged in the area A2b specified in S32 (the area A2b corresponding to the base station apparatus 1b). Then, for example, the second area specifying unit 414 specifies, as an area A3 (hereinafter, also referred to as an area A3b), an area including the specified mesh cell A1 in the fifth row and the first column.

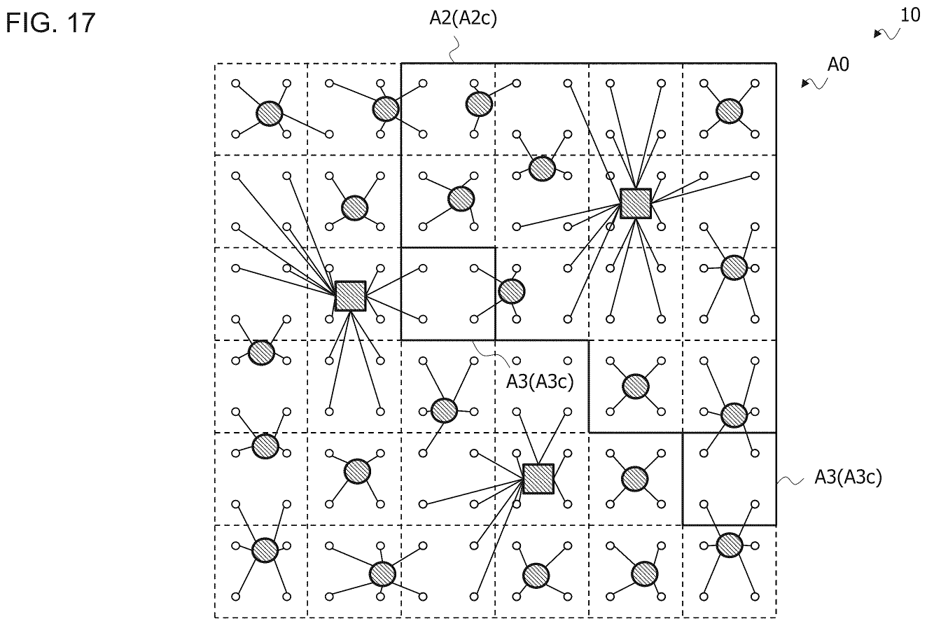

In this case, as illustrated in FIG. 17, for example, the second area specifying unit 414 specifies the mesh cell A1 in the third row and the third column and the mesh cell A1 in the fifth row and the sixth column as the mesh cells A1 that are not included in the area A2c specified in S32 among the mesh cells A1 included in the second area corresponding to each base station apparatus 2 arranged in the area A2c specified in S32 (the area A2c corresponding to the base station apparatus 1c). Then, for example, the second area specifying unit 414 specifies, as an area A3 (hereinafter, also referred to as an area A3c), an area including the specified mesh cell A1 in the third row and the third column and the specified mesh cell A1 in the fifth row and the sixth column.

Returning to FIG. 5, for example, the third area specifying unit 415 specifies, as the third area corresponding to each base station apparatus 1, an area including the first area corresponding to each base station apparatus 1 and the second area corresponding to each of the plurality of base station apparatuses 2 arranged in the first area corresponding to each base station apparatus 1, for each of the plurality of base station apparatuses 1 (S34).

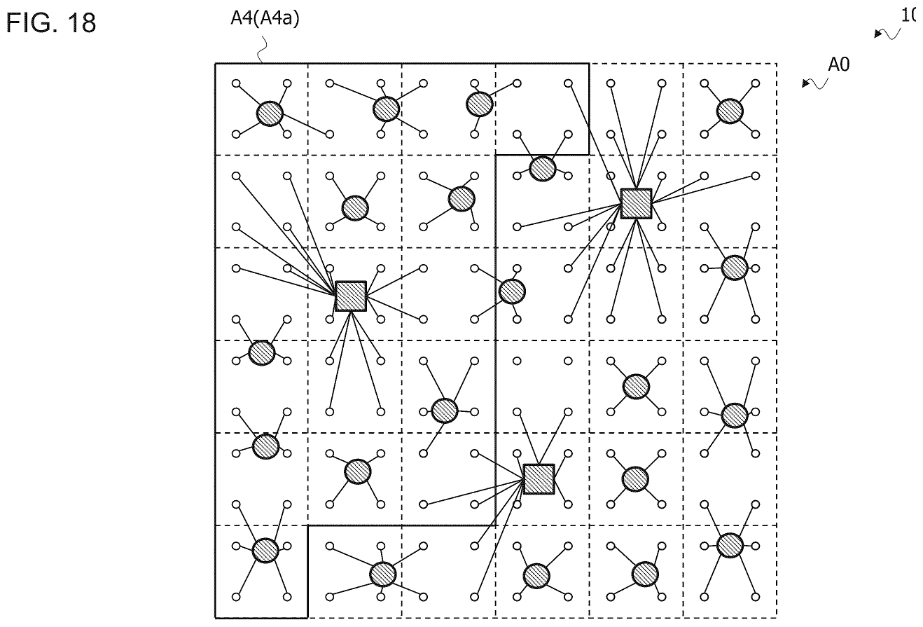

Specifically, as illustrated in FIG. 18, for example, the third area specifying unit 415 specifies, as the third area corresponding to the base station apparatus 1a, an area A4 (hereinafter, also referred to as an area 4a) including the area A2a and the area A3a corresponding to the base station apparatus 1a.

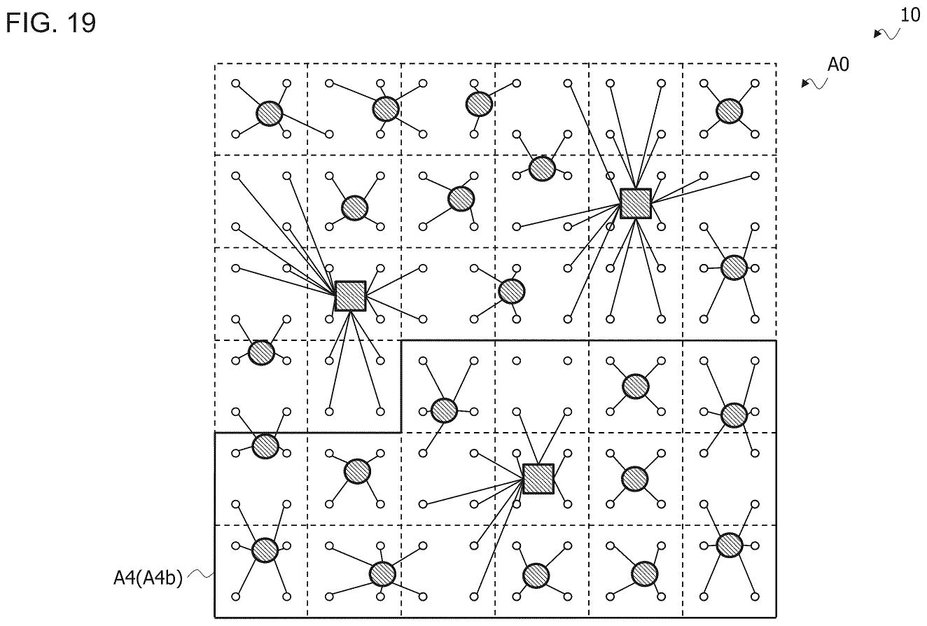

As illustrated in FIG. 19, for example, the third area specifying unit 415 specifies, as the third area corresponding to the base station apparatus 1b, an area A4 (hereinafter, also referred to as an area 4b) including the area A2b and the area A3b corresponding to the base station apparatus 1b.

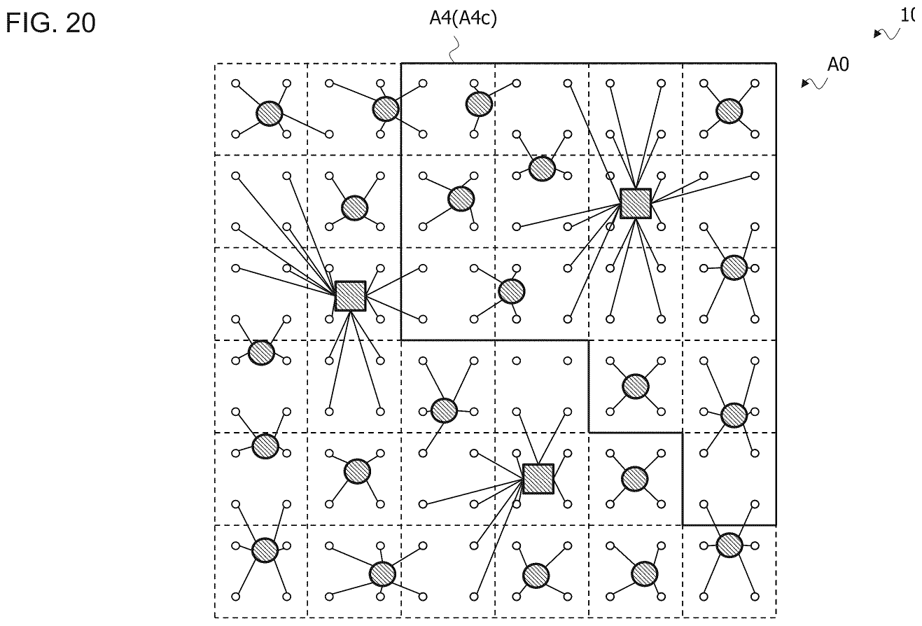

As illustrated in FIG. 20, for example, the third area specifying unit 415 specifies, as the third area corresponding to the base station apparatus 1c, an area A4 (hereinafter, also referred to as an area 4c) including the area A2c and the area A3c corresponding to the base station apparatus 1c.

Then, the information output unit 416 outputs, for example, the area information DT3 indicating the third area corresponding to each of the plurality of base station apparatuses 1 (S35). A specific example of the area information DT3 is described below.

### Specific Example of Area Information

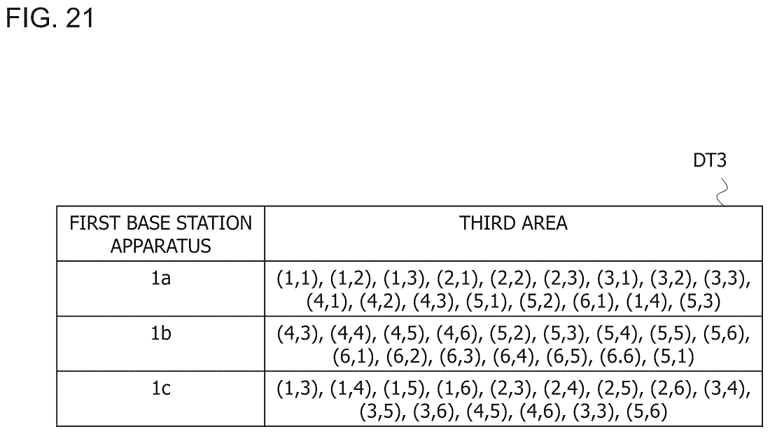

FIG. 21 is a diagram for describing the specific example of the area information DT3.

In the area information DT3 illustrated in FIG. 21, for example, “(1,1)” indicating the mesh cell A1 in the first row and the first column, “(1,2)” indicating the mesh cell A1 in the first row and the second column, “(1,3)” indicating the mesh cell A1 in the first row and the third column, “(2,1)” indicating the mesh cell A1 in the second row and the first column, “(2,2)” indicating the mesh cell A1 in the second row and the second column, “(2,3)” indicating the mesh cell A1 in the second row and the third column, “(3,1)” indicating the mesh cell A1 in the third row and the first column, “(3,2)” indicating the mesh cell A1 in the third row and the second column, “(3,3)” indicating the mesh cell A1 in the third row and the third column, “(4,1)” indicating the mesh cell A1 in the fourth row and the first column, “(4,2)” indicating the mesh cell A1 in the fourth row and the second column, “(4,3)” indicating the mesh cell A1 in the fourth row and the third column, “(5,1)” indicating the mesh cell A1 in the fifth row and the first column, “(5,2)” indicating the mesh cell A1 in the fifth row and the second column, and “(6,1)” indicating the mesh cell A1 in the sixth row and the first column are set as the third area corresponding to the base station apparatus 1a.

That is, in the area information DT3 illustrated in FIG. 21, for example, information indicating each mesh cell A1 included in the area A2a is set as information regarding the third area corresponding to the base station apparatus 1a.

Further, in the area information DT3 illustrated in FIG. 21, for example, “(1,4)” indicating the mesh cell A1 in the first row and the fourth column and “(5,3)” indicating the mesh cell A1 in the fifth row and the third column are set as the third area corresponding to the base station apparatus 1a.

That is, in the area information DT3 illustrated in FIG. 21, for example, information indicating each mesh cell A1 included in the area A3a is set as the information regarding the third area corresponding to the base station apparatus 1a. Description of other information included in FIG. 21 is omitted.

### Transmission Suspension Control Processing

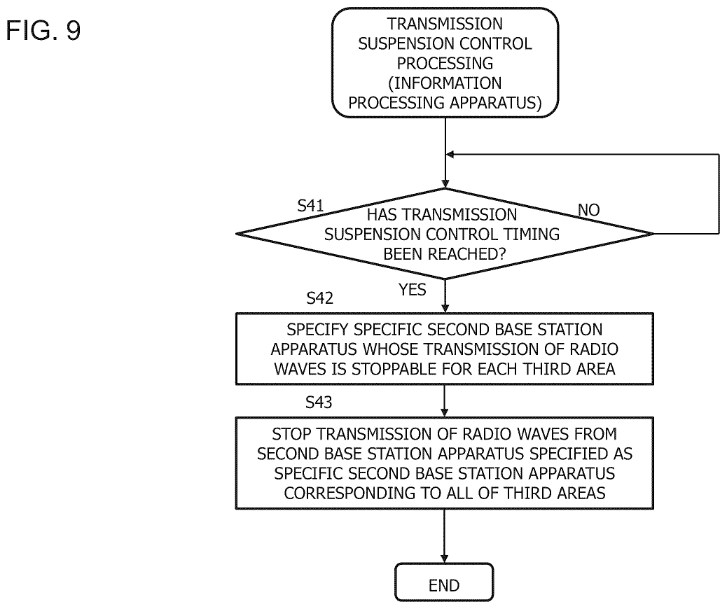

Next, processing of stopping transmission of radio waves from each base station apparatus 2 (hereinafter, also referred to as transmission suspension control processing) in the base station control processing according to the first embodiment will be described. FIG. 9 is a flowchart for describing the transmission suspension control processing.

As illustrated in FIG. 9, the transmission suspension control unit 417 waits until a transmission suspension control timing is reached (NO in S41). The transmission suspension control timing may be, for example, a timing after the area specifying processing is executed, and may be designated by the administrator.

Then, when the transmission suspension control timing has been reached (YES in S41), for example, the transmission suspension control unit 417 specifies, for each of the plurality of base station apparatuses 1, the specific base station apparatus 2 whose transmission of radio waves is stoppable among the plurality of base station apparatuses 2 arranged in the third area corresponding to each base station apparatus 1 (S42).

Specifically, for example, the transmission suspension control unit 417 specifies, by using a trained learning model (hereinafter, also simply referred to as a learning model), a mathematical formula for performing combination optimization, or the like, the specific base station apparatus 2 whose transmission of radio waves is stoppable among the plurality of base station apparatuses 2 arranged in the third area corresponding to each base station apparatus 1 such that power consumption in the plurality of base station apparatuses 2 is minimized and a traffic load in the base station apparatus 2 that transmits radio waves does not become equal to or higher than a threshold (for example, a PRB usage ratio is 100% or more).

The learning model may be, for example, a learning model generated for each of the plurality of base station apparatuses 1 (the third area corresponding to each of the plurality of base station apparatuses 1), and may be a learning model generated by learning training data corresponding to each base station apparatus 1. Further, the training data corresponding to each base station apparatus 1 may be, for example, training data including the first base station information DT1 corresponding to the plurality of base station apparatuses 1, the second base station information DT2 corresponding to each of the plurality of base station apparatuses 2 arranged in the first area corresponding to each base station apparatus 1, an amount of traffic (performance data) generated in each base station apparatus 1, and an amount of traffic (performance data) generated in each of the plurality of base station apparatuses 2 arranged in the first area corresponding to each base station apparatus 1.

Thereafter, for example, the transmission suspension control unit 417 stops transmission of radio waves from the base station apparatuses 2 specified as the specific second base station apparatuses 2 corresponding to all of the plurality of base station apparatuses 1 (all of the third areas corresponding to the plurality of base station apparatuses 1) among the plurality of base station apparatuses 2 (S43).

Specifically, for example, for each third area of each of the plurality of base station apparatuses 1, the transmission suspension control unit 417 specifies the specific base station apparatus 2 whose transmission of radio waves is stoppable among the plurality of base station apparatuses 2 included in each third area. Then, for example, the transmission suspension control unit 417 stops transmission of radio waves from the base station apparatuses 2 specified as the specific base station apparatuses 2 corresponding to all the third areas among the plurality of base station apparatuses 2.

That is, for example, in a case where there is a base station apparatus 2 (hereinafter, also referred to as an overlapping base station apparatus 2) arranged in an area in which a plurality of third areas overlap each other, when the overlapping base station apparatus 2 is specified as the specific base station apparatus 2 for some of the plurality of third areas and is not specified as the specific base station apparatus 2 for some other of the plurality of third areas, the transmission suspension control unit 417 does not stop transmission of radio waves from the overlapping base station apparatus 2.

As described above, in the wireless communication system 10 according to the present embodiment, the first area in which the communication status with each base station apparatus 1 satisfies the first condition is specified for each of the plurality of base station apparatuses 1 based on, for example, the first base station information DT1 regarding each of the plurality of base station apparatuses 1 arranged in the predetermined area.

Then, in the wireless communication system 10 according to the present embodiment, the second area in which the communication status with each base station apparatus 2 satisfies the second condition is specified for each of the plurality of base station apparatuses 2 based on, for example, the first base station information DT1 regarding each of the plurality of base station apparatuses 1 and the second base station information DT2 regarding each of the plurality of base station apparatuses 2 arranged in the predetermined area.

Furthermore, in the wireless communication system 10 according to the present embodiment, for example, the third area including the first area corresponding to each base station apparatus 1 and the second area corresponding to each of the plurality of base station apparatuses 2 arranged in the first area corresponding to each base station apparatus 1 is specified for each of the plurality of base station apparatuses 1. Thereafter, in the wireless communication system 10 according to the present embodiment, for example, the area information DT3 indicating the third area for each of the plurality of base station apparatuses 1 is output.

That is, the wireless communication system 10 according to the present embodiment specifies, for example, the first area in which the terminal apparatus 3 having a high possibility of being connected to each base station apparatus 1 is arranged for each of the plurality of base station apparatuses 1. In addition, the wireless communication system 10 according to the present embodiment specifies, for example, the second area including an area in which the terminal apparatus 3 having a high possibility of being connected to each base station apparatus 2 arranged in the first area corresponding to each base station apparatus 1 is arranged and which is not included in the first area corresponding to each base station apparatus 1. Then, the wireless communication system 10 according to the present embodiment specifies, for example, the third area including the specified first area and the specified second area as an area to be subjected to the transmission suspension control.

As a result, the wireless communication system 10 according to the present embodiment can suppress the execution of the transmission suspension control in a form in which traffic with some terminal apparatuses 3 connected to each base station apparatus 1 or each base station apparatus 2 arranged in the first area corresponding to each base station apparatus 1 is not considered even when the area to be subjected to the transmission suspension control is set in a divided manner, for example. Therefore, the wireless communication system 10 according to the present embodiment can accurately specify the specific base station apparatus 2, for example, even in a case where the area to be subjected to the transmission suspension control is set to be narrow. Accordingly, the wireless communication system 10 according to the present embodiment can accurately specify the specific base station apparatus 2 while reducing the amount of calculation accompanying the execution of the transmission suspension control, for example.

In the above example, a case where the base station control processing is processing of specifying the third area, which is a unit for performing the transmission suspension control of each base station apparatus 2, has been described, but the base station control processing is not limited thereto. Specifically, the base station control processing according to the present embodiment may be, for example, processing of specifying the third area, which is a unit for performing transmission power control or tilting angle control of each base station apparatus 2.

Further, after specifying the third area corresponding to each base station apparatus 1 in S34 described in FIG. 8, for example, the third area specifying unit 415 may determine a combination (hereinafter, also simply referred to as a combination) of two or more third areas, which are adjacent to each other and in which the total number of base station apparatuses 2 included in each third area is equal to or less than a predetermined threshold (hereinafter, also simply referred to as a predetermined threshold) exists in the third area corresponding to each base station apparatus 1. In a case where it is determined that the combination exists, for example, the third area specifying unit 415 may execute processing of integrating two or more third areas included in the combination determined to exist into one third area (hereinafter, also referred to as integration processing).

Specifically, in the example described with reference to FIGS. 18 to 20, for example, in a case where the total number (hereinafter, also referred to as a first total number) obtained by adding the number (hereinafter, also referred to as a first number) of base station apparatuses 2 arranged in the third area (area A4a) corresponding to the base station apparatus 1a (hereinafter, also referred to as a third base station apparatus 1a) and the number (hereinafter, also referred to as a second number) of base station apparatuses 2 arranged in the third area (area A4b) corresponding to the base station apparatus 1b (hereinafter, also referred to as a fourth base station apparatus 1b) is equal to or less than a predetermined threshold, the third area specifying unit 415 may specify an area (hereinafter, also referred to as a fourth area) including the third area corresponding to the base station apparatus 1a and the third area corresponding to the base station apparatus 1b. Then, in this case, for example, the information output unit 416 may generate and output the area information DT3 including information indicating the specified fourth area instead of the third area corresponding to the base station apparatus 1a and the third area corresponding to the base station apparatus 1b.

As a result, the wireless communication system 10 according to the present embodiment can reduce, for example, the number of third areas, which are units for performing the transmission suspension control, and can perform the transmission suspension control more efficiently.

Further, in a case where it is determined that a plurality of combinations exist, for example, the third area specifying unit 415 may temporarily perform integration processing of integrating two or more third areas included in each combination into one third area for each of the plurality of combinations. Then, for example, the third area specifying unit 415 may specify a combination having the smallest variation in the number of base station apparatuses 2 included in the plurality of third areas (the plurality of third areas including the integrated third area) after the integration processing is executed among the plurality of combinations, and adopt a processing result (a processing result of the integration processing) corresponding to the specified combination.

Specifically, in the example described with reference to FIGS. 18 to 20, for example, in a case where the first total number is equal to or less than the predetermined threshold, and the total number (hereinafter, also referred to as a second total number) obtained by adding the first number of the plurality of base station apparatuses 2 arranged in the third area (area A4a) corresponding to the base station apparatus 1a and the number (hereinafter, also referred to as a third number) of base station apparatuses 2 arranged in the third area (area A4c) corresponding to the base station apparatus 1c (hereinafter, also referred to as a fifth base station apparatus 1c) is equal to or less than a predetermined threshold, the third area specifying unit 415 may further specify an area (hereinafter, also referred to as a fifth area) including the third area corresponding to the base station apparatus 1a and the third area corresponding to the base station apparatus 1c. Then, for example, in a case where a difference between the first total number and the third number is smaller than a difference between the second total number and the second number, the information output unit 416 may generate and output the area information DT3 including information indicating the specified fourth area instead of the third area corresponding to the base station apparatus 1a and the third area corresponding to the base station apparatus 1b. On the other hand, for example, in a case where the difference between the first total number and the third number is larger than the difference between the second total number and the second number, the information output unit 416 may generate and output the area information DT3 including information indicating the specified fifth area instead of the third area corresponding to the base station apparatus 1a and the third area corresponding to the base station apparatus 1c.

As a result, the wireless communication system 10 according to the present embodiment can equalize, for example, the processing load (processing time) of the transmission suspension control performed in parallel.

According to one aspect, it is possible to efficiently perform the transmission suspension control.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is;

1. An information processing apparatus comprising:
a memory; and
a processor coupled to the memory and the processor configured to:
specify, for each of a plurality of first base station apparatuses arranged in a predetermined area, a first area which is an area in which a communication status with each first base station apparatus satisfies a first condition, based on first information regarding each of the plurality of first base station apparatuses;
specify, for each of a plurality of second base station apparatuses arranged in the predetermined area, a second area which is an area in which a communication status with each second base station apparatus satisfies a second condition, based on the first information regarding each of the plurality of first base station apparatuses and second information regarding each of the plurality of second base station apparatuses;
specify, for each of the plurality of first base station apparatuses, a third area including the first area corresponding to each first base station apparatus and the second area corresponding to each of the plurality of second base station apparatuses arranged in the first area corresponding to each first base station apparatus; and
output information indicating the third area for each first base station apparatus.

2. The information processing apparatus according to claim 1, wherein
the first information regarding each of the plurality of first base station apparatuses includes location information of each of the plurality of first base station apparatuses, and
the second information regarding each of the plurality of second base station apparatuses includes location information of each of the plurality of second base station apparatuses.

3. The information processing apparatus according to claim 1, wherein
the first information regarding each of the plurality of first base station apparatuses includes a height of an antenna of each of the plurality of first base station apparatuses, transmission power of radio waves from each of the plurality of first base station apparatuses, and a frequency of radio waves from each of the plurality of first base station apparatuses, and
the second information regarding each of the plurality of second base station apparatuses includes a height of an antenna of each of the plurality of second base station apparatuses, transmission power of radio waves from each of the plurality of second base station apparatuses, and a frequency of radio waves from each of the plurality of second base station apparatuses.

4. The information processing apparatus according to claim 1, wherein
the communication status with each first base station apparatus is a communication status between each first base station apparatus and a communication device arranged in the first area corresponding to each first base station apparatus.

5. The information processing apparatus according to claim 1, wherein
the communication status with each second base station apparatus is a communication status between each second base station apparatus and a communication device arranged in the second area corresponding to each second base station apparatus.

6. The information processing apparatus according to claim 1, wherein
the processor specifies the first area corresponding to each first base station apparatus in a case where radio waves are transmitted from each of the plurality of first base station apparatuses and radio waves are not transmitted from each of the plurality of second base station apparatuses.

7. The information processing apparatus according to claim 1, wherein
the processor specifies the second area corresponding to each second base station apparatus in a case where radio waves are transmitted from each of the plurality of first base station apparatuses and the plurality of second base station apparatuses.

8. The information processing apparatus according to claim 1, wherein
the processor specifies, for each of the plurality of first base station apparatuses, an area in which a communication device for which a received intensity of radio waves from each first base station apparatus is highest is arranged as the first area corresponding to each first base station apparatus.

9. The information processing apparatus according to claim 1, wherein
the processor specifies, for each of the plurality of second base station apparatuses, an area in which a communication device for which received intensity of radio waves from each second base station apparatus is highest is arranged as the second area corresponding to each second base station apparatus.

10. The information processing apparatus according to claim 1, wherein
in a case where a first total number obtained by adding a first number of the plurality of second base station apparatuses arranged in the third area corresponding to a third base station apparatus among the plurality of first base station apparatuses and a second number of the plurality of second base station apparatuses arranged in the third area corresponding to a fourth base station apparatus among the plurality of first base station apparatuses is equal to or less than a predetermined threshold, the processor specifies a fourth area including the third area corresponding to the third base station apparatus and the third area corresponding to the fourth base station apparatus, and
the processor outputs the specified fourth area instead of the third area corresponding to the third base station apparatus and the third area corresponding to the fourth base station apparatus.

11. The information processing apparatus according to claim 10, wherein
in a case where the first total number is equal to or less than the predetermined threshold, and a second total number obtained by adding the first number and a third number of the plurality of second base station apparatuses arranged in the third area corresponding to a fifth base station apparatus among the plurality of first base station apparatuses is equal to or less than the predetermined threshold, the processor further specifies a fifth area including the third area corresponding to the third base station apparatus and the third area corresponding to the fifth base station apparatus, and
the processor outputs the specified fourth area instead of the third area corresponding to the third base station apparatus and the third area corresponding to the fourth base station apparatus in a case where a difference between the first total number and the third number is smaller than a difference between the second total number and the second number, and outputs the specified fifth area instead of the third area corresponding to the third base station apparatus and the third area corresponding to the fifth base station apparatus in a case where the difference between the first total number and the third number is larger than the difference between the second total number and the second number.

12. The information processing apparatus according to claim 1, wherein
the processor performs, for each third area for each first base station apparatus, transmission suspension control of the plurality of second base station apparatuses included in each third area.

13. The information processing apparatus according to claim 12, wherein
the processor specifies, for each third area for each first base station apparatus, a specific second base station apparatus whose transmission of radio waves is stoppable among the plurality of second base station apparatuses included in each third area, and
the processor stops transmission of radio waves from the plurality of second base station apparatuses specified as the specific second base station apparatuses corresponding to all of the third areas for the respective first base station apparatuses.

14. An area specifying method comprising:
specifying, for each of a plurality of first base station apparatuses arranged in a predetermined area, a first area which is an area in which a communication status with each first base station apparatus satisfies a first condition, based on first information regarding each of the plurality of first base station apparatuses;
specifying, for each of a plurality of second base station apparatuses arranged in the predetermined area, a second area which is an area in which a communication status with each second base station apparatus satisfies a second condition, based on the first information regarding each of the plurality of first base station apparatuses and second information regarding each of the plurality of second base station apparatuses;
specifying, for each of the plurality of first base station apparatuses, a third area including the first area corresponding to each first base station apparatus and the second area corresponding to each of the plurality of second base station apparatuses arranged in the first area corresponding to each first base station apparatus; and
outputting information indicating the third area for each first base station apparatus.
